(19) United States
(12) Patent Application Publication
(10) Pub. No.: US 2025/0034767 A1
(43) Pub. Date: Jan. 30, 2025

(54) Fiber with Multi-filament Structure and Textile Fabric, Curtain, and Screen Incorporating Such Fiber

(71) Applicant: CHUNG MING TEXTILES ENTERPRISE CO., LTD., Taichung City (TW)

(72) Inventor: Chun-Chia CHEN, Taichung City (TW)

(21) Appl. No.: 18/782,521

(22) Filed: Jul. 24, 2024

(30) Foreign Application Priority Data
Jul. 26, 2023 (TW) 112207857

(51) Int. Cl. D04B 1/16; D02G 3/02; D04B 21/08; D06M 13/288; D06M 15/256; D06M 15/263; D06M 101/32; D06N 3/00; D06N 3/04

(52) U.S. Cl. CPC D04B 1/16; D02G 3/02; D04B 21/08; D06M 13/288; D06M 15/256; D06M 15/263; D06N 3/0009; D06N 3/0036; D06N 3/0059; D06N 3/042; D06N 3/047; D06M 2101/32; D06M 2200/12; D06M 2200/30; D06N 2201/02; D06N 2209/067; D06N 2209/142; D06N 2211/00; D06N 2211/122; D10B 2331/04; D10B 2403/0114; D10B 2503/00; D10B 2503/02

(57) ABSTRACT

The present invention provides a fiber with a multi-filament structure and a textile fabric, curtain, and screen incorporating such fiber. The multi-filament fiber includes multiple filaments and a blended material. Each filament is a columnar body arranged adjacently or in a spiral adjacent arrangement to form a yarn having an appropriate length. The blended material contains a nano-fluorine water-repellent material and a bonding material provided in gaps between the filaments. Multiple fibers are arranged at intervals horizontally or vertically and knitted in the weft or warp direction to form a meshed textile fabric. The fabric is further coated with an adhesive and a nano-fluorine water-repellent material for use in screens, thereby achieving water repellency and air pollution prevention. Meanwhile, the meshed textile fabric exhibits improved stiffness, elasticity, and transparency, making it suitable for retractable screen fabrics.

### FIELD OF INVENTION

The present invention relates to a yarn for textiles, in particular a fiber with a multi-filament structure, and its use in textile fabrics, curtains, and screens.

### BACKGROUND OF THE INVENTION

The atmosphere at the Earth's surface provides the oxygen essential for human respiration. Emissions and dust from factories, exhaust and dust from human activities, and transportation all contribute to air pollution. Particulate matter (PM), dust, and particles in the air not only pollute the home environment, but also adversely affect human respiratory health and plant respiration mechanisms.

Conventional window and door screens are primarily designed to keep insects out while allowing ventilation. However, the mesh size of these screens cannot prevent smog and dust from entering the home with the air, nor can they prevent rainwater from entering the home on rainy days.

To maintain a clean home environment, some manufacturers have developed metal wire mesh screens with an electrostatic nanofilm layer on both the inner and outer surfaces to filter particulate matter (PM) while providing water repellency and ventilation. However, the electrostatic nanofilm layer on the mesh surface is not durable when exposed to wind and sunlight, and its production cost is high. Other manufacturers have developed screens using multiple screen yarns, each coated with sodium polyacrylate, a water-absorbing polymer. This material expands when wet and contracts when dry, opening and closing the gaps between the screen yarns to provide water resistance and ventilation. However, sodium polyacrylate's poor heat resistance and inability to withstand prolonged sun exposure are significant drawbacks.

There are window screens on the market that are made of textile fabric woven in a shuttle (plain) weave and coated with a water-repellent layer. These screens are effective at blocking particulate matter (PM), dust, or sand, while maintaining air circulation and repelling rainwater. However, the spatial structure of the shuttle (plain) weave is prone to yarn slippage. When used in architectural window screens and installed in window frames, the water-repellent coating can cause the fabric to slip out of the frame, resulting in an uneven screen surface that compromises aesthetics. Additionally, it is not suitable for use in retractable screens due to its lack of elasticity and flexibility.

### SUMMARY OF THE INVENTION

The primary purpose of the present invention is to provide a fiber with a multi-filament structure and textile fabrics, curtains, and screens incorporating such fiber, which can block dust, particulate matter (PM), and sand in the air while also preventing water penetration, repelling water, blocking rainwater from entering indoor spaces, and maintaining ventilation at a low cost.

A secondary purpose of the present invention is to provide a fiber with a multi-filament structure and textile fabrics, curtains, and screens incorporating such fiber, which have a longer service life.

Another purpose of the present invention is to provide a fiber with a multi-filament structure and textile fabrics, curtains, and screens incorporating such fiber, which can be used in window screens, retractable screen fabrics, and agricultural planting fields.

An additional purpose of the present invention is to provide a fiber with a multi-filament structure and textile fabrics, curtains, and screens incorporating such fiber, which have flame-retardant properties for home safety.

To achieve the aforementioned purposes, the present invention provides a fiber with a multi-filament structure and textile fabrics, curtains, and screens incorporating such fiber. The multi-filament fiber includes at least multiple filaments and a blended material. Each filament is a columnar body arranged adjacently or in a spiral adjacent arrangement to form a yarn having an appropriate length. The blended material includes at least a nano-fluorine water-repellent material and a bonding material provided in the gaps between the filaments. The present invention further uses the multiple fibers arranged at intervals in the left-right direction or the multiple fibers arranged at intervals in the up-down direction to form a meshed textile fabric through knitting in the weft or warp direction. The meshed textile fabric is further coated with an adhesive and a nano-fluorine water-repellent material for use in screens to achieve water repellency and air pollution prevention. The meshed textile fabric also has better stiffness, elasticity, and transparency, making it suitable for use in a retractable screen fabric.

The following are some of the preferred embodiments of the present invention, which are further described in detail with the following drawings:

### BRIEF DESCRIPTION OF THE DRAWINGS

FIG. 1 is a schematic partial enlarged view of a yarn in a preferred embodiment according to the present invention;

FIG. 2 is a schematic partial enlarged view of a yarn in another preferred embodiment according to the present invention;

FIG. 3 is a schematic view of a fiber in a preferred embodiment according to the present invention;

FIG. 3A is a schematic enlarged cross-sectional view along the 3a-3a direction of FIG. 3;

FIG. 4 is a schematic enlarged structural view of a textile fabric woven according to the present invention;

FIG. 5 is another schematic enlarged structural view of a textile fabric woven according to the present invention;

FIG. 6 is a schematic exploded structural view of a textile fabric with a coating layer on one side according to the present invention; and

FIG. 7 is a schematic exploded structural view of a textile fabric with a coating layers on both sides according to the present invention.

### DETAILED DESCRIPTION OF THE PREFERRED EMBODIMENTS

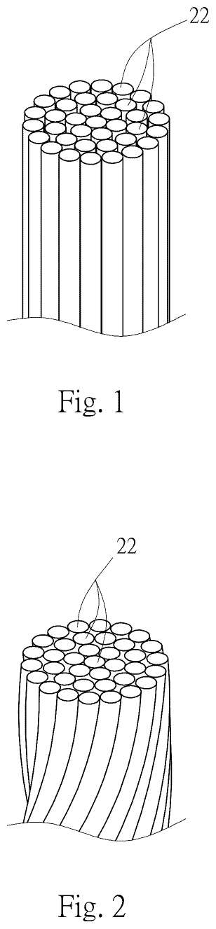

Reference is made to FIGS. 1, 2, 3 and 3A. The present invention discloses a fiber 12 of a composite yarn of greige, which includes at least multiple small filaments 22 and a blended material 14. Each filament 22, such as a polyester fiber or a polyethylene terephthalate (PET) fiber, is a columnar body having an appropriate length and is arranged adjacently (FIG. 1) or in a spiral adjacent arrangement (FIG. 2) to form a yarn having an appropriate length. The yarn is formed by approximately 12-96 filaments 22 so-called composite yarn, with a weight of about 20-150 denier or 20-600 denier.

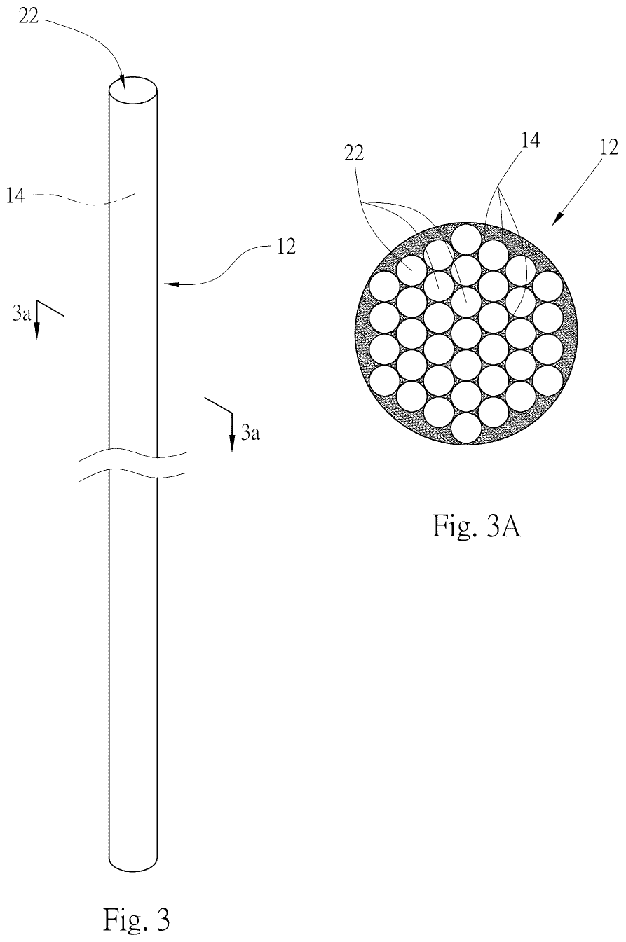

Referring again to FIG. 3, the present invention uses the blended material 14 by coating it on the yarn or immersing the yarn in the blended material 14, so that the blended material 14 is distributed in the gaps between the filaments 22 and/or coated on the outer periphery of the yarn. The blended material 14 includes at least a nano-fluorine water-repellent material, such as perfluoroalkyl ethyl acrylate copolymer nano-fluorine water-repellent, and a bonding material, and further includes a flame-retardant material, thereby imparting water repellency and flame retardant/fireproof properties to the present invention.

The water-repellent material can be a mixture of water, perfluoroalkyl ethyl acrylate copolymer, and dipropylene glycol methyl ether. The bonding material, such as an adhesive like ethyl acetate, is used to adhere the blended material 14 to the yarn. In the present invention, the perfluoroalkyl ethyl acrylate copolymer water-repellent is used to impart a hydrophobic property to the yarn, as well as to achieve sun resistance, heat resistance, transparency, and wash resistance, thereby increasing the life of the yarn. Perfluoroalkyl ethyl acrylate copolymer is commercially available. Of course, other types of water-repellents with the water-repellent property can also be obtained commercially, but perfluoroalkyl ethyl acrylate copolymer has better performance. In addition, non-fluorinated acrylic copolymers can also be used as water-repellents to achieve the above effects.

The flame-retardant material can include compounds containing C₁₅H₃₁O₉P₃ (flame-retardant FRC-1) and C₉H₂₀O₆P₂ (methyl (5-ethyl-2-methyl-2-oxido-1,3,2-dioxaphosphinan-5-yl)methyl methylphosphonate).

During the yarn spinning process, each filament 22 can be mixed with multiple colored powders or color masterbatches, and the colored powders are distributed in the pores of each filament 22 to form colored monofilament yarn. The color of the colored powder or color masterbatch can be black, purple, or green to form monofilament yarn that is opaque or not completely transparent. If each filament 22 is not mixed with colored powders or color masterbatches during the spinning process, the resulting monofilament yarn will be transparent or not completely transparent.

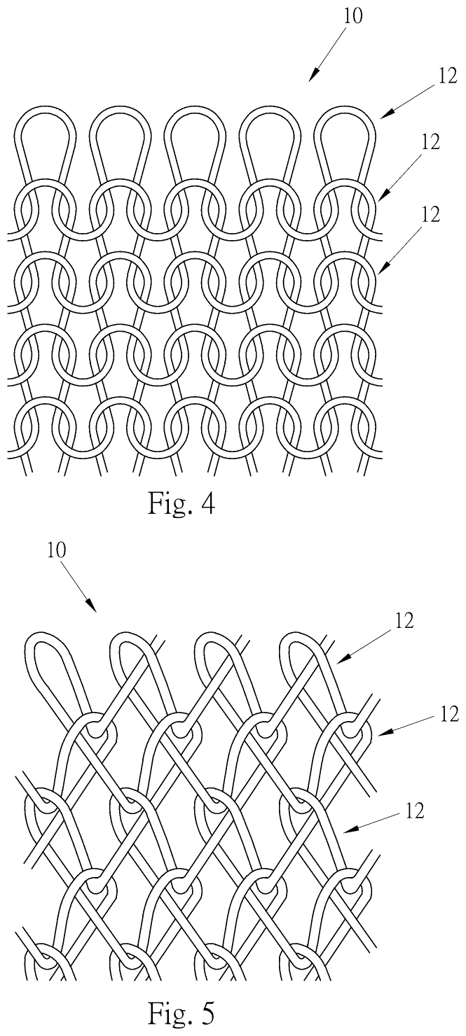

With reference to FIGS. 4 and 5, the present invention uses multiple fibers 12 arranged at intervals in the left-right direction or multiple fibers 12 arranged at intervals in the up-down direction to form a meshed textile fabric 10 through knitting in the weft direction (as in FIG. 4) or in the warp direction (as in FIG. 5), which can be achieved by using a knitting machine. In the knitting method, crocheting is used to produce the weft- or warp-knitted textile fabric having a series of arranged loops and the weft- or warp-knitted textile fabric having a number of loops in the course and wale directions. The mesh is defined as the number of loops in the course direction multiplied by the number of loops in the wale direction in an area of 1 square inch. The mesh of the knitted textile fabric 10 in the present invention can be set to 500-2000 meshes.

Due to the durability of the meshed textile fabric 10, the number of loops in the course and wale directions, and the 500-2000 meshes, it can effectively prevent particulate matter (PM), dust, or sand in the air from passing through while maintaining air circulation and transparency. Therefore, using the meshed textile fabric 10 as an agricultural planting screen can effectively prevent air pollution on leaves, flowers, and fruits while maintaining air circulation, and using the meshed textile fabric 10 as a smog-proof window screen in the construction industry can effectively prevent air pollution indoors while maintaining air circulation.

Furthermore, due to its better elasticity/flexibility, the knitted meshed textile fabric 10 is also more suitable for use in retractable screen fabrics, curtain or roller blind.

In addition, one knitting method for the meshed textile fabric 10 is to knit one side of the corresponding two sides of the textile fabric 10 with the fiber 12 of 40-60 denier in the weft direction and the other side with the fiber 12 of 130-150 denier in the weft direction. In other words, using a circular knitting machine to produce a double-sided interlocked mesh structure in weft knitting, or using a warp knitting machine to produce a mesh structure in warp knitting on the corresponding two sides. As a result, the meshed textile fabric 10 has a relatively fine side and a rough side on its respective two sides. The rough side corresponds to the exterior having a better filtering effect, while the fine side corresponds to the interior having a light-transmitting effect.

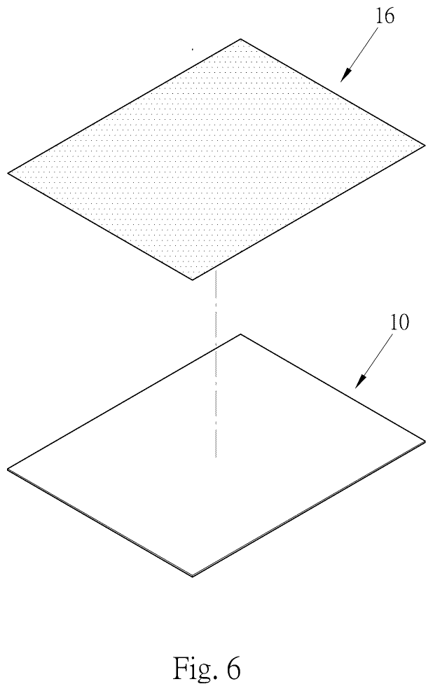

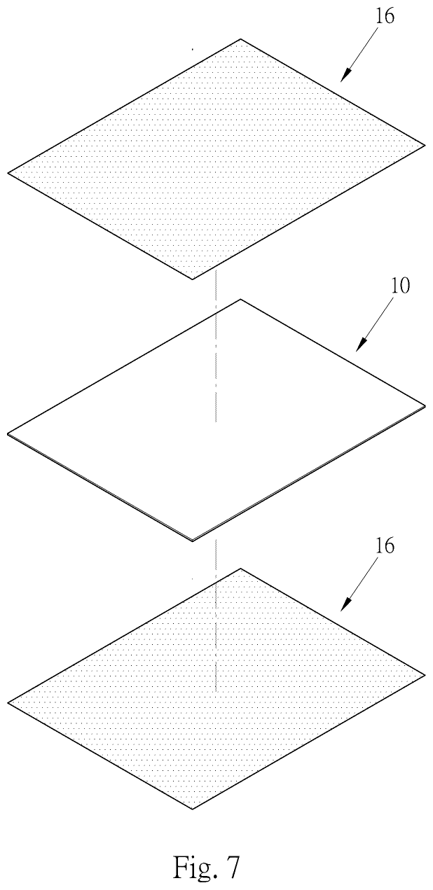

With reference to FIGS. 6 and 7, the meshed textile fabric 10 further includes a coating layer 16. The coating layer 16 includes at least the aforementioned water-repellent material and the bonding material, and further includes the aforementioned flame-retardant material, which enhances the water-repellent and flame retardant/fireproof properties of the present invention. The coating layer 16 is processed by rolling, heating, and drying to form a fixed shape, coating one side of the meshed textile fabric 10 (as shown in FIG. 6), both corresponding sides of the meshed textile fabric 10 (as shown in FIG. 7), or the surface of each fiber 12. Thus, the meshed textile fabric 10 can be stiff and flat without sagging, and its woven structure can be maintained to provide better degree of freedom in subsequent use. Wherein the adhesive in the coating layer 16 can be ethyl acetate. Each filament 22 can adopt the polyethylene terephthalate (PET) fiber to make the meshed textile fabric 10 have a stiffer and flatter effect.

In the present invention, water repellency is enhanced by the nano-fluorine water-repellent material used in the blended material 14 and/or the coating layer 16. When applied to the window screen and left open on a rainy day, rain water hardly adheres to the screen, thus eliminating the concern of water seeping into the interior. In addition, dust adhering to the screen can be easily washed off with water or carried away by rain.

By incorporating the flame-retardant material into the blended material 14 and/or the coating layer 16, the present invention achieves flame retardant and fireproof properties.

Furthermore, the meshed textile fabric 10 disclosed in the present invention can be made without the blended material 14 on each fiber 12 but with the coating layer 16 and still achieve water-repellent/water-resistant, durable, mold-resistant, and flame retardant/fireproof properties. In the manufacturing process, this eliminates the step of coating the yarn with the blended material 14 or immersing the yarn in the blended material 14. The coating layer 16 is applied to the meshed textile fabric 10 only after the yarn is knitted, which can reduce manufacturing costs.

In the present invention, high-polymer greige composite yarn is used as the base material. Its surface or exterior is coated with adhesive resin and nano-fluorine water-repellent to form fibers that exhibit weather adaptability, UV resistance, and color fastness. This solution addresses the issues of poor heat resistance associated with sodium polyacrylate and the high cost of metal yarn.

The present invention uses the surface tension of the water-repellent material of the coating layer 16 to make the meshed textile fabric 10 prevent the passage of haze/smog and have a more anti-haze effect.

In the present invention, the blended material 14 or the coating layer 16 can comprise an emulsifier such as a cleaning agent/detergent for completely mixing. Preferably the emulsifier can be a solvent-free cleaning agent/detergent.

The present invention employs a knitted textile fabric having a loop structure in the course and wale directions, which makes it less prone to yarn slippage. In particular, when used in architectural window screens and installed in window frames, the loop structure of the present invention provides better slip resistance and is less likely to slip out of the window frame, providing a better assembly degree of freedom.

What is claimed is:

1. A textile fabric of multi-filament fiber, comprising at least:
multiple filaments, each filament being a columnar body selected from a group consisting of an adjacent arrangement and a spiral adjacent arrangement to form a yarn having an appropriate length, wherein multiple yarns arranged at intervals in the left-right direction or multiple yarns arranged at intervals in the up-down direction are used to form a group selected from a meshed textile fabric and a textile fabric with 500-2000 meshes by knitting in being selected from a group consisting of a warp direction and a weft direction; and
a coating layer, the coating layer including a group selected from a water-repellent and an adhesive, and a water-repellent, an adhesive; and a flame retardant, used to coat a group selected from both corresponding sides of the textile fabric, one side of the corresponding two sides of the textile fabric, and the surface of each fiber.

2. The textile fabric according to claim 1, wherein each filament is made of being selected from a group consisting of polyester fiber material and polyethylene terephthalate fiber.

3. The textile fabric according to claim 1, wherein the weight of the yarn is 20-600 denier.

4. The textile fabric according to claim 1, wherein the water-repellent material is selected from a group consisting of perfluoroalkyl ethyl acrylate copolymer and acrylic copolymer.

5. The textile fabric according to claim 1, wherein the flame retardant material comprises C₁₅H₃₁O₉P₃ (flame retardant FRC-1) and C₉H₂₀O₆P₂ (methyl (5-ethyl-2-methyl-2-oxido-1,3,2-dioxaphosphinan-5-yl)methyl methylphosphonate).

6. The textile fabric according to claim 1, wherein one side of the corresponding two sides of the textile fabric is knitted with the yarn of 40-60 denier, and the other side is knitted with the yarn of 130-150 denier, resulting in the corresponding two sides of the textile fabric having a relatively fine side and a rough side.

7. The textile fabric according to claim 2, wherein one side of the corresponding two sides of the textile fabric is knitted with the yarn of 40-60 denier, and the other side is knitted with the yarn of 130-150 denier, resulting in the corresponding two sides of the textile fabric having a relatively fine side and a rough side.

8. The textile fabric according to claim 3, wherein one side of the corresponding two sides of the textile fabric is knitted with the yarn of 40-60 denier, and the other side is knitted with the yarn of 130-150 denier, resulting in the corresponding two sides of the textile fabric having a relatively fine side and a rough side.

9. The textile fabric according to claim 4, wherein one side of the corresponding two sides of the textile fabric is knitted with the yarn of 40-60 denier, and the other side is knitted with the yarn of 130-150 denier, resulting in the corresponding two sides of the textile fabric having a relatively fine side and a rough side.

10. The textile fabric according to claim 5, wherein one side of the corresponding two sides of the textile fabric is knitted with the yarn of 40-60 denier, and the other side is knitted with the yarn of 130-150 denier, resulting in the corresponding two sides of the textile fabric having a relatively fine side and a rough side.

11. A curtain, comprising the textile fabric according to claim 1.

12. A screen, comprising the textile fabric according to claim 1.
